(19) United States
(12) Patent Application Publication
(10) Pub. No.: US 2008/0201157 A1
(43) Pub. Date: Aug. 21, 2008

(54) METHODS, SYSTEMS, AND COMPUTER SOFTWARE UTILIZING XBRL TO ELECTRONICALLY LINK THE ACCOUNTING RECORDS OF MULTI-PERIOD CONTRACTS AND MULTI-PERIOD LOANS AND GRANTS FOR MANAGEMENT

(76) Inventor: Richard Timothy MCNAMAR, Falls Church, VA (US)

Correspondence Address: FOLEY AND LARDNER LLP;SUITE 500, 3000 K STREET NW, WASHINGTON, DC, 20007, US

(21) Appl. No.: 11/740,616

(22) Filed: Apr. 26, 2007

Related U.S. Application Data
(60) Provisional application No. 60/794,834, filed on Apr. 26, 2006.
(60) Provisional application No. 60/794,858, filed on Apr. 26, 2006.
(60) Provisional application No. 60/794,821, filed on Apr. 26, 2006.
(60) Provisional application No. 60/794,835, filed on Apr. 26, 2006.
(60) Provisional application No. 60/794,836, filed on Apr. 26, 2006.
(60) Provisional application No. 60/794,838, filed on Apr. 26, 2006.
(60) Provisional application No. 60/794,822, filed on Apr. 26, 2006.
(60) Provisional application No. 60/841,529, filed on Sep. 1, 2006.
(60) Provisional application No. 60/844,674, filed on Sep. 15, 2006.
(60) Provisional application No. 60/845,777, filed on Sep. 20, 2006.
(60) Provisional application No. 60/908,050, filed on Mar. 26, 2007.

(51) Int. Cl. G06Q 10/00

(52) U.S. Cl. 705/1

(57) ABSTRACT

A method, system and program product for managing a multi-period contract, comprising: receiving or extracting or generating new contract data on one or more of contracts, changes to the contracts, cost data, changes to the cost data; creating or updating with the new contract data an XBRL multi-period contract record comprising XBRL data fields containing contract data made for different periods in a contract and associated metadata representing attributes at the data field level based on a contract taxonomy, some of the metadata relating to a pertinent time or date for the data, wherein the creating or updating comprises converting the new contract data into values in one or more of the XBRL data fields and associating metadata thereto based on context data for the new contract data and forming links between and/or among at least two items selected from one or more of the categories of the data fields, metadata and components associated with the data fields in the XBRL multi-period contract record; receiving a selection of one of the data fields; obtaining a plurality of data items from current and earlier contract periods associated with the data field; performing an algorithm on the plurality of data items from the current and earlier contract periods to obtain algorithm calculation results; and communicating the algorithm calculation results. In a further embodiment, a disbursement document may be approved or audited based on a disbursement taxonomy and non-conformance determined.

### CROSS-REFERENCE TO RELATED PATENT APPLICATIONS

This application claims priority from Provisional U.S. Application 60/794,858, filed Apr. 26, 2006, Provisional U.S. Application 60/794,821, filed Apr. 26, 200, Provisional U.S. Application 60/794,838, filed Apr. 26, 2006, Provisional U.S. Application 60/794,834, filed Apr. 26, 2006, Provisional U.S. Application 60/794,835, filed Apr. 26, 2006, Provisional U.S. Application 60/794,836, filed Apr. 26, 2006, Provisional U.S. Application 60/794,822, filed Apr. 26, 2006, Provisional U.S. Application 60/841,529, filed Sep. 1, 2006, Provisional U.S. Application 60/844,674, filed Sep. 15, 2006, Provisional U.S. Application 60/845,777, filed Sep. 20, 2006, from Provisional U.S. Application 60/908,050, filed Mar. 26, 2007. The entire contents of the aforementioned applications are incorporated herein by reference.

### BACKGROUND

The United States Government, state and local governments, non-United States governments, private companies, and multilateral financial institutions have multi-period contracts that they must account for over time. These government contracts are often large multi-year construction projects, such as building a dam or mass transit system. In the private sector, the contract may be for the construction of a new office or manufacturing building, installing the equipment in the building, testing it, etc.

In this patent application the term “contract” is used to cover a contract for services, construction contract, contract to buy a tangible product, or a contract to design and develop a new tangible or intangible product, e.g. software. The contract is always owned by the contracting party, a corporation or government entity, and performed by the contractor who is being paid to perform the contract.

At present, the contracting records are not electronically linked and nor are they linked to the financial records that record the multi-year contract cost of the contract. While there may be detailed memoranda explaining necessary changes to the contract, they are at best only cross-referenced and again, not linked to the government entities general ledger or accounting financial records for the contract.

As a result of these factors, auditors cannot readily identify the changes in the contracts that led to the changes in the financial record of the contract or construction project. This introduces errors in auditing or evaluating the performance of the companies performing the contracts.

Likewise, the United States Department of Defense (“DoD”) expends billions of dollars on weapons systems design, development, production, and deployment every year. Managing these multi-year contracts is a major challenge to the military services and civilian management in the DoD. In addition, understanding the weapons systems contracting process and auditing their management is complex and oversight by the Service IG or the DoD IG, the Government Accountability Office or the Congress is very time consuming, expensive, and difficult.

Likewise, the weapons systems and contracting records are not electronically linked nor are they linked to the financial records that record the multi-year contract cost of the weapon system. In addition, some of the documents have a security classification and others are public further complicating their retention, management, and searching and relating them.

As a result of these factors, auditors cannot readily identify the changes in the contracts that led to the changes in the financial record of the weapons system contract. This introduces errors in auditing or evaluating the weapons systems contracts.

The turnover in program managers for weapons system acquisition programs further introduces a loss of institutional memory that complicates the management of the contract itself, much less the audit of the contract. Some weapon systems contracts are decades long in duration. The B-52 weapon system was introduced in 1954 is fifty-two years old and has had many thousands, if not hundred of thousands of modifications. The FI5A dates from the early 1970's. Even the Humvee is almost 25 years old. With the turnover in weapons system acquisition management over this length of time explaining the weapon system's accounting records and design or production modifications is a major challenge.

The Integrated Defense Acquisition, Technology & Logistics Life Cycle Management Framework is the overall management process that integrates the Joint Capabilities Integration & Development System, Defense Acquisition System, and Planning, Programming, Budgeting & Execution Process. (See FIG. 1) (Also see www.http://akss.dau.mil/ifc/) for on line version. This process is used by all Service Branches of the DoD for weapons system acquisition, deployment, operations and support.

Typically all multi-year contracts will have a number of phases, such as:
Concept Refinement
Engineering and Architects Design
Refinement and Pilot Demonstrations
Production & Execution
Support & Maintenance

Given the sophistication and complexity of any multi-year contract, there are innumerable changes throughout the process. This makes it particularly difficult to track the changes over the years and relate them to the financial cost accounting for the project, building, or new company product being developed. On audit, an approved change that affects the original per unit production cost may not be properly documented and identified and therefore it appears to be a production cost overrun, when in fact, the extra cost was an approved design change.

The difficulty in maintaining and locating documents over many months or years is compounded by the turnover of personnel at the government agency contracting for the services or the contractor providing the services. What may have been wide-spread institutional memory at the time of the contract modification is lost with the promotion, transfer, retirement of personnel working for the entity that awarded the contract.

In addition, while computer records and paper records may be cross-referenced, they can also be misfiled, or simply, not locatable due to the passage of time and inevitable turnover in personnel with an institutional memory. Even computer records (e.g., Word documents or Excel spread sheets) may only reference the relevant memorandum explaining the approved change. The documents are not linked in any way that includes a linkage of the financial record and the memorandum explaining or supporting accounting changes in the contract approved for change at the time.

### ADDITIONAL BACKGROUND

Commercial banks in the United States and throughout the world make bank loans that are multi-period. Similarly, the multi-lateral financial institutions such as the World Bank, the Inter-American Development Bank, the Asian Development bank and others make multi-period loans and grants. In the United States, the Millenium Challenge Corporation is specifically set up to make not loans, but grants to developing countries that have economic policies that are judged to promote economic growth and poverty alleviation.

Whether from a multinational financial institution or a commercial bank, loans to a country or a corporation have a term of years and normally a disbursement schedule, and terms for repayment after some time, including perhaps a grace period in which no interest or principal is repaid. They also often have a period when only interest is paid.

The grants by the Millenium Challenge Corporation to high performing developing countries are new, but have characteristics of a loan from a funds disbursement standpoint. However, as a grant to the country, government entity, or corporation in the country, the grant does not have a repayment schedule.

Hence regardless of the institution and whether the funds disbursements are to be repaid (as a loan) or for the recipient's use and investment without repayment (a grant), there is a need to manage the disbursement of funds under the contractual agreement with the lender or grantor (“the program”). Managing the disbursement of funds under these programs is challenging and fraught with corruption, crime, and mismanagement.

Audits of these programs are often performed annually or sometime after the fact. Routinely, a number of recurring problems are identified in the audit phase of the disbursement program. First, the documentation that authorizes the disbursement is non-existent, lost, or somehow inadequate. Second, unauthorized individuals authorize the funds disbursement. Third the recipient of the funds disbursement is often not eligible for the disbursement. Fourth, the entity representing to be the recipient is often not who they purport to be. Fifth, the funds may have been disbursed prior to agreed upon milestones being met, or only partially met. Sixth, the method of disbursement is not an agreed upon method, e.g., funds versus a certified check or equivalent. Seventh, where the program lender or grantor is using an intermediate agent to manage the further micro-disbursement of the funds, the records of this intermediary's disbursement may be non-existent.

Thus, domestic and international program disbursements are not adequately controlled to minimize or eliminate theft, misdirection of the disbursement, or to ensure that the disbursement goes to the qualified and intended recipient. As a result, the records to support a rigorous accounting of the disbursements (or audit of the disbursements) are often non-existent or missing, particularly in developing countries.

Historically, lending institutions have employed internal auditors and external public auditors to provide an accounting of the disbursements under a program. There are computerized systems to track loan and grant disbursement activities by a variety of measures. The auditors attempt to review the Authorization Memorandum that initiates the disbursement process, the Disbursement Approval Memorandum, and the Funds Disbursement Order for the funds to be paid by wire transfer, check, or in funds, and the record of the funds disbursement whether by wire transfer, check, or in funds.

While the names of the activities may be dissimilar in different financial institutions, these are the three generic activities or documents that are present in all funds disbursement activities; authorization, disbursement approval, and the funds disbursement order. Upon audit by the disbursement agency, one or more of these paper documents or their back-up may be missing or irregular in some form. For example, the recipient of a check, money order, or wire transfer may not be the individual contemplated in the original Authorization Memorandum.

In the case of computerized systems, the authorization memo, disbursement approval, and funds disbursement files, programs, and records may not be located together or even cross-referenced electronically. The computer security for access to the disbursement system may be lax and the procedures for the authentication process not followed. There may or may not be a computer record of the process and whether it was followed or not.

This situation is made more complicated by a change in personnel associated with the disbursement process. This may be due to promotions in the lending/granting agency or the borrowing entity. Terminations, deaths, and transfers will also undermine the institutional knowledge of the individual disbursements.

At present, the disbursement records are not electronically linked and nor are they linked to the financial records that record the program loan or grant. While there may be detailed memoranda explaining necessary changes in the original loan or grant, they are at best only cross-referenced and again, not linked to the disbursing agencies general ledger or accounting financial record for the agreed disbursement contract.

As a result of these factors, auditors cannot readily perform their audits. This introduces errors in auditing or evaluating the performance of the companies performing the contracts. This makes it particularly difficult to track the changes in disbursement decisions or policies over the years and relate them to the accounting for the disbursements.

The difficulty in maintaining and locating documents over many months or years is compounded by the turnover of personnel at the disbursing bank or financial institution has already been noted. Likewise, the same problems noted previously also arise relating to misfiling, records not locatable due to the passage of time and lose of institutional memory. Even computer records (e.g., Word documents or Excel spread sheets widely used in banking) may only reference the relevant disbursement approval memoranda. These documents are not referenced or electronically linked in any way that links the Authorization Memorandum, the Disbursement Approval Memorandum, and the Funds Disbursement Order with the accounting entry in the disbursing bank or agency's financial records.

### SUMMARY OF THE EMBODIMENTS

In a first embodiment, there is presented a method for managing a multi-period contract, comprising receiving or extracting or generating new contract data on one or more of contracts, changes to the contracts, cost data, changes to the cost data, creating or updating with the new contract data an XBRL multi-period contract record comprising XBRL data fields containing contract data made for different periods in a contract and associated metadata representing attributes at the data field level based on a contract taxonomy, some of the metadata relating to a pertinent time or date for the data, wherein the creating or updating comprises converting the new contract data into values in one or more of the XBRL data fields and associating metadata thereto based on context data for the new contract data and forming links between and/or among at least two items selected from one or more of the categories of the data fields, metadata and components associated with the data fields in the XBRL multi-period contract record, receiving a selection of one of the data fields, obtaining a plurality of data items from current and earlier contract periods associated with the data field, performing an algorithm on the plurality of data items from the current and earlier contract periods to obtain algorithm calculation results, and communicating the algorithm calculation results.

In a further embodiment, the data field is a disbursement data field, wherein the algorithm determines if a change to a disbursement data item has associated therewith a valid change authority.

In a further embodiment, the data field is a disbursement data field, wherein the algorithm determines if a disbursement data item is associated with or correlates to an authorized appropriation amount.

In a further embodiment, the data items from the earlier contract periods are ranked based on a criterion.

In a further embodiment, the criterion is fiscal year.

In a further embodiment, the data field is a cost data field, wherein the obtaining step obtains changes to cost data items in the cost data field made in the past, and wherein changes to the cost data item are correlated with changes to equipment being procured under the contract.

In a further embodiment, the data field is a cost data field, wherein the algorithm determines if a change to a cost data item has associated therewith a valid change authority.

In a further embodiment, the data field is a maintenance record field for equipment procured under the contract, wherein XBRL links are provided between the maintenance record data field and one or more XBRL values in data fields for past maintenance activity, past maintenance cost, maintenance disbursements, a due date for a next maintenance, funds available for the next maintenance, and one or more drawings for the equipment, and wherein the algorithm is a maintenance algorithm that calculates a parameter based on the one or more XBRL values.

In a further embodiment, the maintenance algorithm calculates a projected cost based at least in part, on one or more past maintenance cost data values.

In a further embodiment, the maintenance algorithm determines if a disbursement data item is associated with or correlates to a valid maintenance disbursement authority.

In a further embodiment, the received contract data is from a plurality of different contracts.

In a second embodiment, there is presented a system for managing a multi-period contract, comprising a data repository, and one or more processors operably connected to the data repository for implementing the following components: a component for receiving or extracting or generating new contract data on one or more of contracts, changes to the contracts, cost data, changes to the cost data, a component for creating or updating with the new contract data an XBRL multi-period contract record comprising XBRL data fields containing contract data made for different periods in a contract and associated metadata representing attributes at the data field level based on a contract taxonomy, some of the metadata relating to a pertinent time or date for the data, wherein the creating or updating comprises converting the new contract data into values in one or more of the XBRL data fields and associating metadata thereto based on context data for the new contract data and forming links between and/or among at least two items selected from one or more of the categories of the data fields, metadata and components associated with the data fields in the XBRL multi-period contract record, a component for receiving a selection of one of the data fields, a component for obtaining a plurality of data items from current and earlier contract periods associated with the data field, a component for performing an algorithm on the plurality of data items from the current and earlier contract periods to obtain algorithm calculation results, and a component for communicating the algorithm calculation results.

In a third embodiment, there is presented a program product for managing a multi-period contract, comprising one or more computer usable media having computer readable program code embodied therein or among them, to be executed by a computer, the computer readable program code comprising program code for receiving or extracting or generating new contract data on one or more of contracts, changes to the contracts, cost data, changes to the cost data, program code for creating or updating with the new contract data an XBRL multi-period contract record comprising XBRL data fields containing contract data made for different periods in a contract and associated metadata representing attributes at the data field level based on a contract taxonomy, some of the metadata relating to a pertinent time or date for the data, wherein the creating or updating comprises converting the new contract data into values in one or more of the XBRL data fields and associating metadata thereto based on context data for the new contract data and forming links between and/or among at least two items selected from one or more of the categories of the data fields, metadata and components associated with the data fields in the XBRL multi-period contract record, program code for receiving a selection of one of the data fields, program code for obtaining a plurality of data items from current and earlier contract periods associated with the data field, program code for performing an algorithm on the plurality of data items from the current and earlier contract periods to obtain algorithm calculation results, and program code for communicating the algorithm calculation results.

In a fourth embodiment, there is presented a method for financial compliance, comprising receiving a disbursement document for purposes of authorization and/or audit, wherein disbursement data in the disbursement document is extracted as XBRL data and/or converted to XBRL data with associated metadata representing attributes at the data value level in the data field based on a disbursement taxonomy and including links to data relating to at least one from the group of authorization documents and explanation documents and appropriation documents, performing a validation algorithm on the XBRL data and determining any non-conformance, and communicating any non-conformance or an approval.

In a further embodiment, there is a non-conformance, and the method further comprises determining a materiality of the non-conformance in the audit trail.

In a further embodiment, one of the data fields is an authorization field, wherein the validation algorithm compares a name in the authorization field to one or more persons who can authorize the disbursement.

In a further embodiment, one of the data fields is a recipient, wherein the validation algorithm compares a name in the recipient field to one or more persons eligible to receive the disbursement.

In a further embodiment, one of the data fields is a milestones met field, wherein the validation algorithm compares a milestones met value in the milestones met data field to one or more milestones that must be met to qualify for the disbursement.

In a further embodiment, the validation algorithm retrieves an explanation of a data field found and business rules associated therewith.

In a further embodiment, the validation algorithm retrieves an explanation of a data field found and business rules associated therewith in a plurality of documents and ranks them by a predetermined criterion.

In a further embodiment, the predetermined criterion is date of creation.

In a further embodiment, the validation algorithm retrieves all data values over a period of time for a given data field and performs an algorithm on the retrieved data values.

In a further embodiment, the algorithm is an addition algorithm.

In a fifth embodiment, there is presented a system for financial compliance, comprising a data repository, and one or more processors operably connected to the data repository for implementing the following components: a component for receiving a disbursement document for purposes of authorization and/or audit, wherein disbursement data in the disbursement document is extracted as XBRL data and/or converted to XBRL data with associated metadata representing attributes at the data value level in the data field based on a disbursement taxonomy and including links to data relating to at least one from the group of authorization documents and explanation documents and appropriation documents, a component for performing a validation algorithm on the XBRL data and determining any non-conformance, and a component for communicating any non-conformance or an approval.

In a sixth embodiment, there is presented a program product for financial compliance, comprising one or more computer usable media having computer readable program code embodied therein or among them, to be executed by a computer, the computer readable program code comprising program code for receiving a disbursement document for purposes of authorization and/or audit, wherein disbursement data in the disbursement document is extracted as XBRL data and/or converted to XBRL data with associated metadata representing attributes at the data value level in the data field based on a disbursement taxonomy and including links to data relating to at least one from the group of authorization documents and explanation documents and appropriation documents, program code for performing a validation algorithm on the XBRL data and determining any non-conformance, and program code for communicating any non-conformance or an approval.

### BRIEF DESCRIPTION OF THE DRAWINGS

FIG. 1 is a schematic block diagram of the prior art.

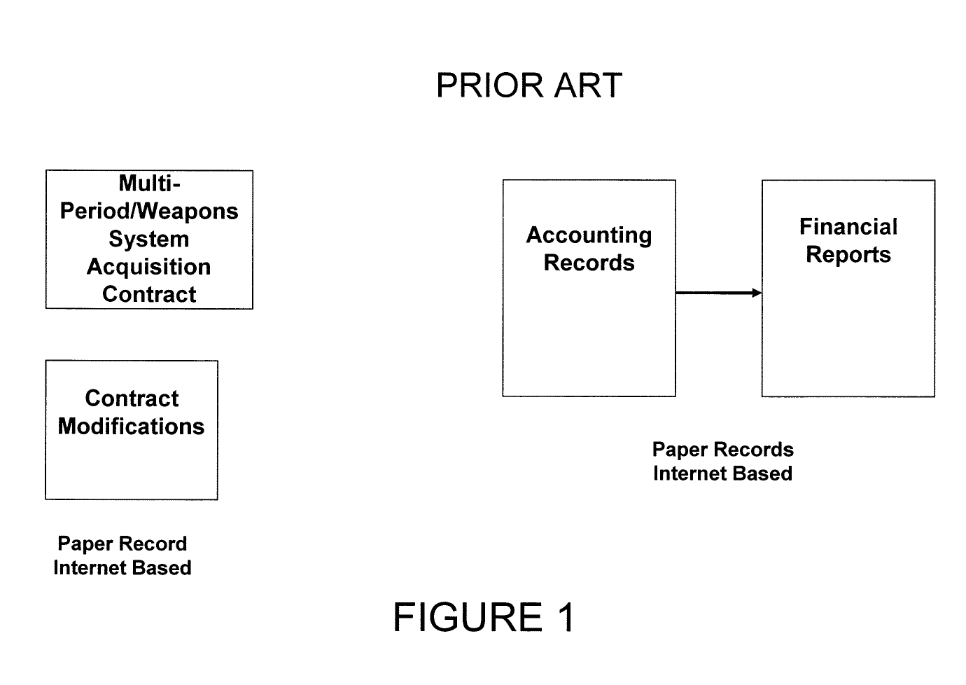

FIG. 2 is a schematic block diagram of a first embodiment of the multi-period contract invention.

FIG. 3 is a schematic block diagram of a first embodiment of the multi-period contract invention.

FIG. 4 is a schematic block diagram of a first embodiment of the multi-period contract invention.

FIG. 5 is a schematic block diagram of a first embodiment of the multi-period contract invention.

FIG. 6 is a schematic block diagram of a first embodiment of the multi-period contract invention.

FIG. 7 is a schematic block diagram of a first embodiment of the multi-period contract invention.

FIG. 8 is a schematic block diagram of a first embodiment of the multi-period contract invention.

FIG. 9 is a schematic block diagram of a first embodiment of the multi-period contract invention.

FIG. 10 is a schematic block diagram illustrating the prior art.

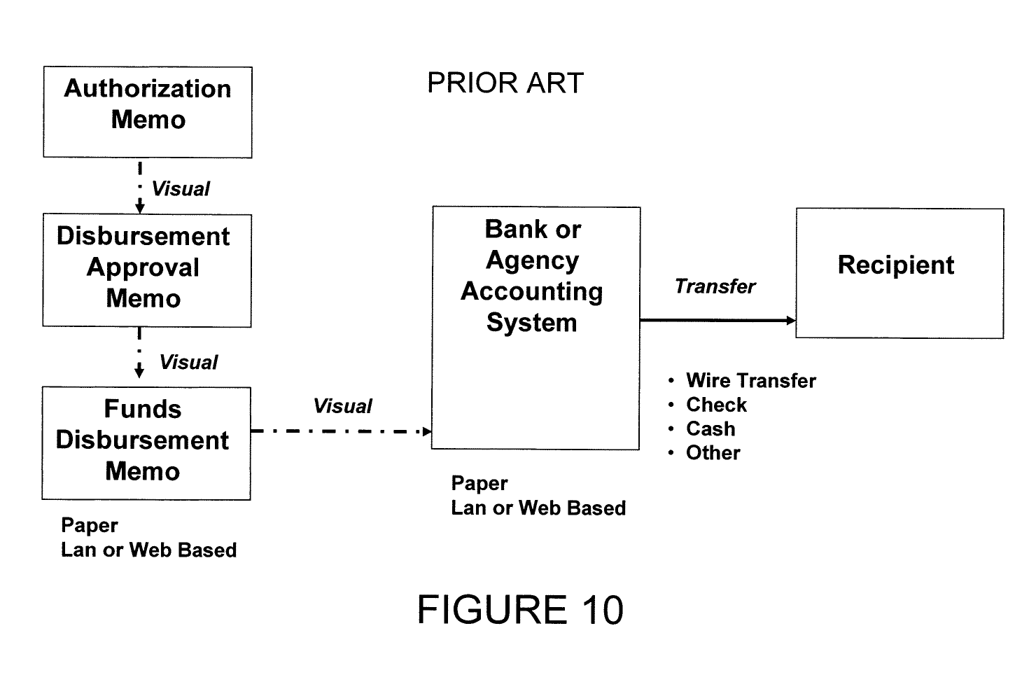

FIG. 11 is a schematic block diagram of one embodiment of the bank or agency loan invention.

FIG. 12 is a schematic block diagram of one embodiment of the bank or agency loan invention.

FIG. 13 is a schematic block diagram of one embodiment of the bank or agency loan invention.

FIG. 14 is a schematic block diagram of one embodiment of the bank or agency loan invention.

FIG. 15 is a schematic block diagram of one embodiment of the bank or agency loan invention.

FIG. 16 is a schematic block diagram of one embodiment of the bank or agency loan invention.

### DETAILED DESCRIPTION OF THE EMBODIMENTS

It should be noted that the term “XBRL” for purposes of this application, is given a special definition that encompasses not only XBRL, but also extensible Mark-up language equivalents that associate components representing attributes at the data value level in the data field based on a taxonomy and create links between or among at least two items selected from one or more of the categories of data fields, metadata, and components associated with the data fields, e.g., between two data field items, or between two metadata items, or between two component items, or between a data field item and an item of metadata, or between a data field item and a component item. By way of example, attributes at the data value level in the data field might relate to what the value represents, e.g., a contract cost value, a measurement scale, e.g., in U.S. dollars, a date when the cost was approved. The attributes will change and be customized depending on the particular application

XBRL provides metadata about each specific data field and content contained within a document by utilizing XBRL components. Thus XBRL enables components to be applied by data field at the most granular level, as opposed to enabling components to be applied at the document level with XML.

XBRL can be implemented to be a standards-based vendor-independent technology. XBRL files are defined by Metadata set out in Taxonomies. Taxonomies capture the definition of individual reporting elements as well as the relationships between elements within a taxonomy and in other taxonomies. Taxonomies are a collection of XML schema documents. Subsequent extensions or adjustments to the taxonomies may be standardized. An XBRL component includes the resources necessary to implement a taxonomy for a data field, such as metadata, elements, tuples, linkbases, and stylesheets, to name a few. Schema defines items (data) and Tuples (concepts). Linkbases are a collection of links that arc concepts to resources. Style Sheets contain a page's semantic content and structure. For example, an XBRL Style Sheet relates to the rendering of text and data for communication. The Instance Document holds business facts, contexts, units, and references. For example, an individual's completed 1040 is an XBRL Instance Document. Selected links may be formed between and/or among the data field items and/or between and among metadata items for the different data fields, and/or between and among each component item (elements, tuples, metadata, and other resources) of the XBRL information taxonomy. These links may be formed by an XBRL conversion engine or alternatively could be formed at a later time by means of a linking program.

A taxonomy for data could be implemented, for example, by multiple private consortia, individual companies, and government agencies designing a taxonomy for the values or ranges of values that would be measured for a given data field. The taxonomy developers would typically also build in a plurality of conformance tests on each data item to insure that each data item entered/matched into a data field was within its appropriate data field parameter location. These conformance test would comprise the application of one or more business rules to specify what data could go into a data field and not accepting any data that does not meet these one or more rules. For example, if the data field is supposed to contain data that is three digits and is not a decimal or a negative number, then the XBRL software will test and validate the incoming data to be sure the key punch operator or another data stream isn't entering a currency value in “dollars.

Further, XBRL allows a robust method of expressing semantic meanings for its data fields, and the relationships between those data fields. This semantic meaning can be expressed by calculations to handle summations, formulas utilizing different data fields, and may also be obtained by a definition linkbase. Thus, another conformance test could include whether the data fields A, B and C, when utilized in a calculation such as A=B+C, give the appropriate results. Thus, data is not just tested to ensure it meets specific formats, but also to ensure that the context of the data, both as a single data item and in relation to other data items, is correct as well.

Because it is the only data standard designed to work with all operating and application software, XBRL can tie together the existing legacy systems in substantially any and all providers. In most situations, no existing software need be replaced with new software just to obtain interoperability. All legacy software is mapped to work together using XBRL as a link or connector.

In selected embodiments, an XBRL file is used to access components such as data and metadata within an XBRL file and subject it to operations such as addition, subtraction, division, multiplication, or comparison with other data by a computer. This means that the data within a record is now understandable to the computer and can be managed on the computer.

Using the present system, in one embodiment data within records can be accessed and analyzed. This is in contrast to a record in XML, which is essentially a picture of the printed page designed to be viewed by humans, but the data in it is inactive. It must be extracted, transferred, and entered into a new computer program. In the present system, XBRL software can monitor changes in values within the XBRL record from year to year within the record's data field without removing it from the patient's file. It is “Interactive.”

An exemplary system for implementing the overall system or portions of the invention include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules and other data for the computer.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Additionally, embodiments within the scope of the present invention include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed or received by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention will be described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

One embodiment comprises an Extensible Business Reporting Language (“XBRL”) enhanced Extensible Markup Language (“XML”) based application software that electronically links a data entry in a contract, such as a DoD weapons acquisition contract, with the contract's financial accounting record with an external memorandum. Over the web, the XML/XBRL application software linkbase base feature will automatically link the numeric entry in the financial records with an alpha-numeric memorandum explaining the context or rationale for the numeric entry in the accounting or financial records. The memorandum may be linked at the time of the numeric financial entry is entered into the accounting records or linked at a subsequent time.

With one click of a computer mouse, a user can locate and read an external memorandum that explains the weapons system acquisition accounting records. This ensures that a user can electronically locate a memorandum prepared before, at the time, or after the data entry that explains the data entry, a change in accounting policies, procedures, or other relevant information to the financial entry.

Some embodiments ensure that the relevant memorandum will be located and electronically linked to the accounting system data entry. This feature eliminates human searches and the errors that human searches can introduce to relating the accounting entry to the rationale or justification for the accounting entry. This saves time and increases accuracy when managing any multi-year contract, or subsequently performing an audit of the contract.

In one embodiment, the results of the linkbase search can be analyzed, transmitted, and displayed on any computer screen with access to the World Wide Web. The software will retrieve multiple external memoranda, prepared at differing times, with the numeric entry into the accounting system, sort or rank them by pre-determined criteria, e.g. date, perform Boolean algebra searches between and among them, and the results compiled and transmitted to a remote computer screen and displayed for viewing, or printing out into a hard copy record.

In another embodiment, appropriate security clearances are needed to access the results of the linkbase search in the methods described above.

### EMBODIMENTS

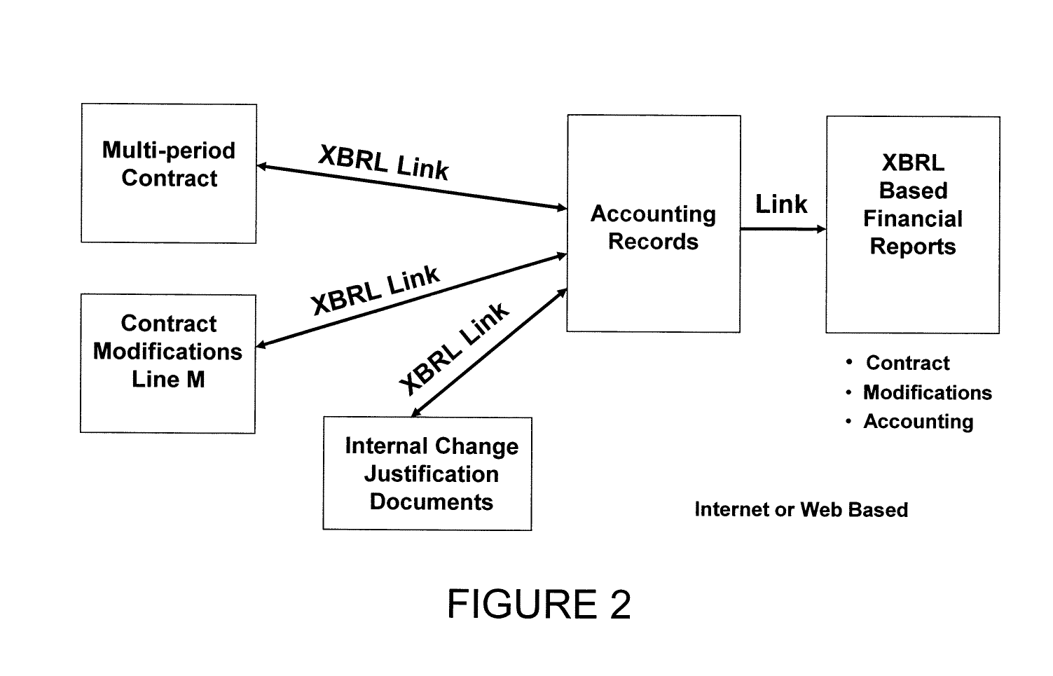

In one embodiment, a multi-year construction contract is initiated. At each stage of the contract, decisions are made to modify the existing contract to meet newly identified requirements, correct past errors, or improve some particular characteristics of the multi-year contracts objectives, e.g. building a mass transit system. There are thousands and thousands of “contract change orders” over the multi-year life of the contract and in each phase of the contract. Each of these thousands and thousands of external memoranda are all individually linked via XBRL components to the numerical entry in the accounting records for the multi-period contract (FIG. 2)

Years after the contract was signed, initiated and work begun, when a third-party or independent outside auditor reviews the contract's administration, management, and accounting, the auditor can use their computer to correlate or pull up the relevant supporting memorandum for the numeric data entry for the year, month, and day the numeric data entry was made in the accounting system. This electronic audit trail minimizes gaps in company or government entities institutional memory, lost paper records, and human search errors. This permits a more accurate audit of what actually took place, the rationale for the changes in the contract and saves time and money while minimizing the possibility for human error.

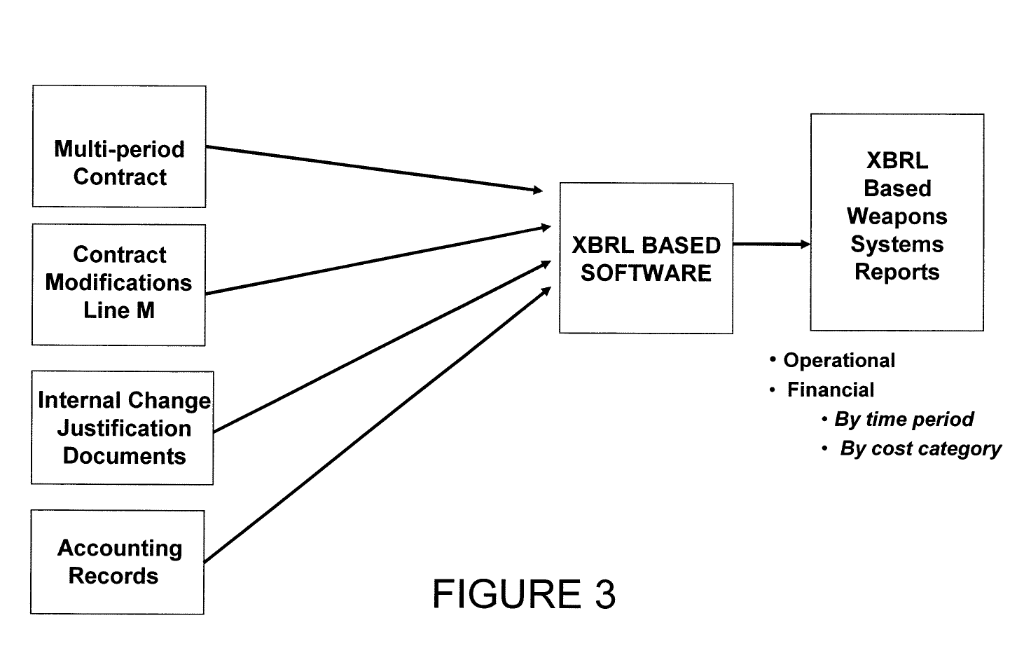

In another embodiment, a program manager or auditor wishes to review all of the multi-year changes in a facet of a contract performed by a specific contractor relating to a particular current cost. All of the work or changes done by contractor X relating to the particular current cost can be arrayed by date, size of change, or other criteria, then computer records analyzed, the results tabulated, transmitted, and displayed remotely on a computer monitor attached to the World Wide Web. (FIG. 3)

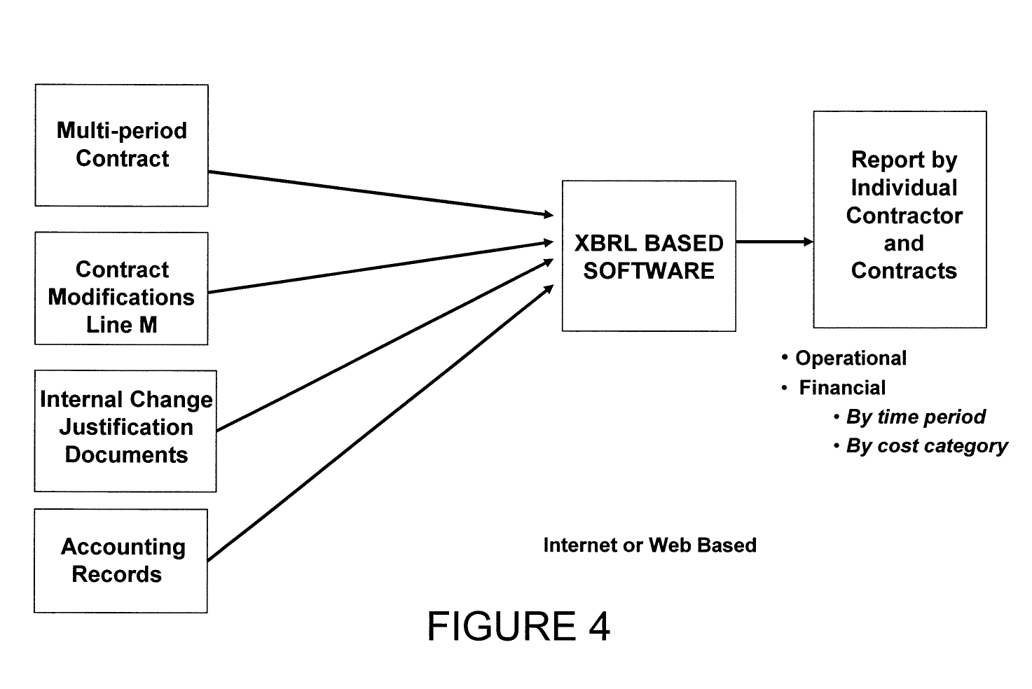

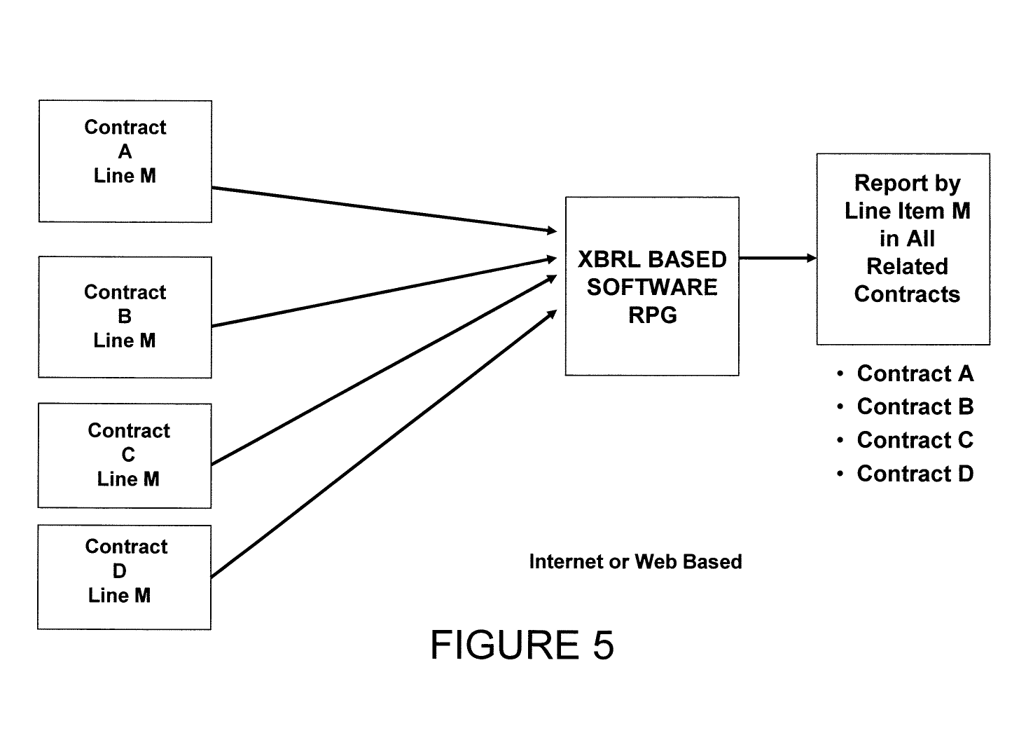

The embodiment permits identification of a line item in the accounting cost system. The operator can then electronically locate all memoranda that relate to that particular line item in the corporation or government entity's contract accounting records over a number of years, whether shown by years, months, or days. This computer search will produce external information relating to one cost category in the accounting record. This reduces cost and provides an assurance that all of the relevant memoranda relating to the particular cost line item were electronically identified for examination by a computer program or human being. After computer identification of the memoranda, they could be analyzed by previously specified criteria, ranked, transmitted, and displayed over the World Wide Web to any operator with the appropriate security clearance. (FIGS. 4 and 5)

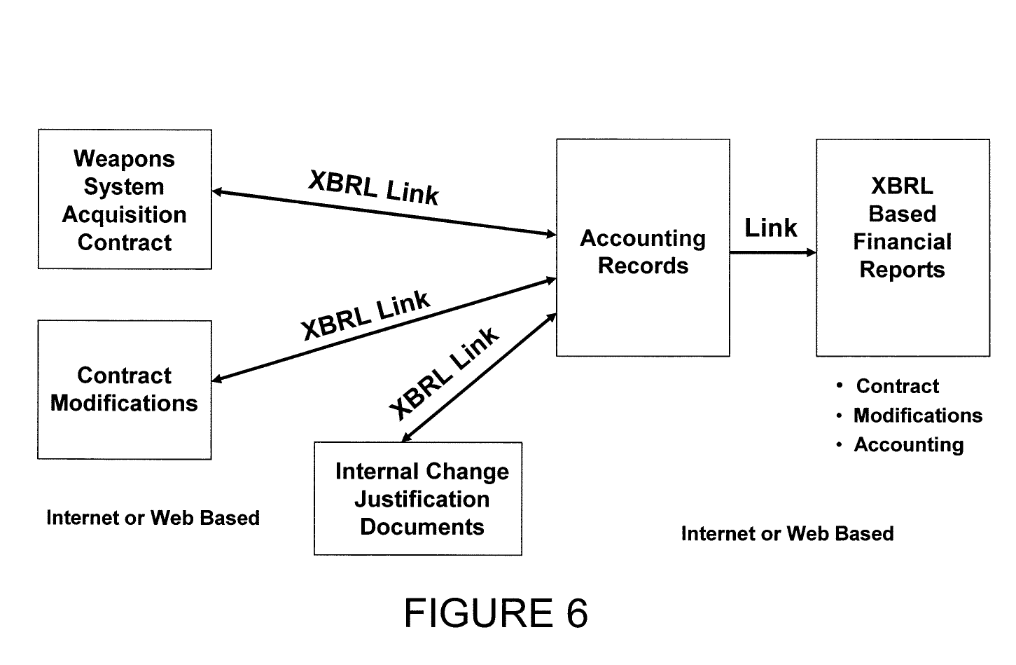

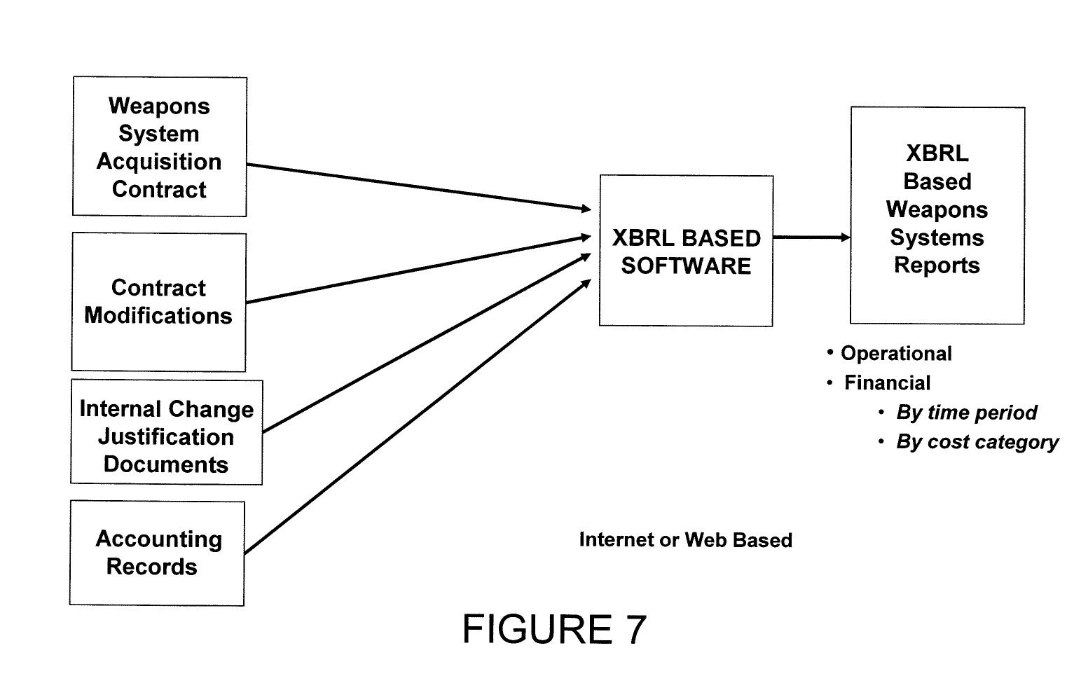

In one embodiment, a multi-year weapons system contract is initiated to develop the system's concept, identify and define its technology, develop and demonstrate the prototype system, produce and deploy the weapons system and operationally maintain it. At each stage of the contract, decisions are made to modify the existing contract to meet newly identified requirements, correct past errors, or improve some particular feature of the weapons system. There are thousands and thousands of “contract change orders” over the multi-year or decades life of the weapons system's development, production, modification, servicing, and eventual retirement. Each of these thousands and thousands of external memorandums are all individually linked to the numerical entry in the accounting records for the weapons system. (FIGS. 6 and 7.)

Years after the weapons system acquisition contract was initiated, when a third-party or independent auditor reviews the weapons systems contract administration, management, and accounting, they can use their computer to correlate or pull up the relevant supporting memorandum for the numeric data entry for the year, month, and day the numeric data entry was made in the accounting system. This electronic audit trail minimizes gaps in the DoD institutional memory, lost paper records, and human search errors. This permits a more accurate audit of what actually took place, the rationale for the changes in the weapons accounting system, and saves time and money while minimizing the possibility for human error.

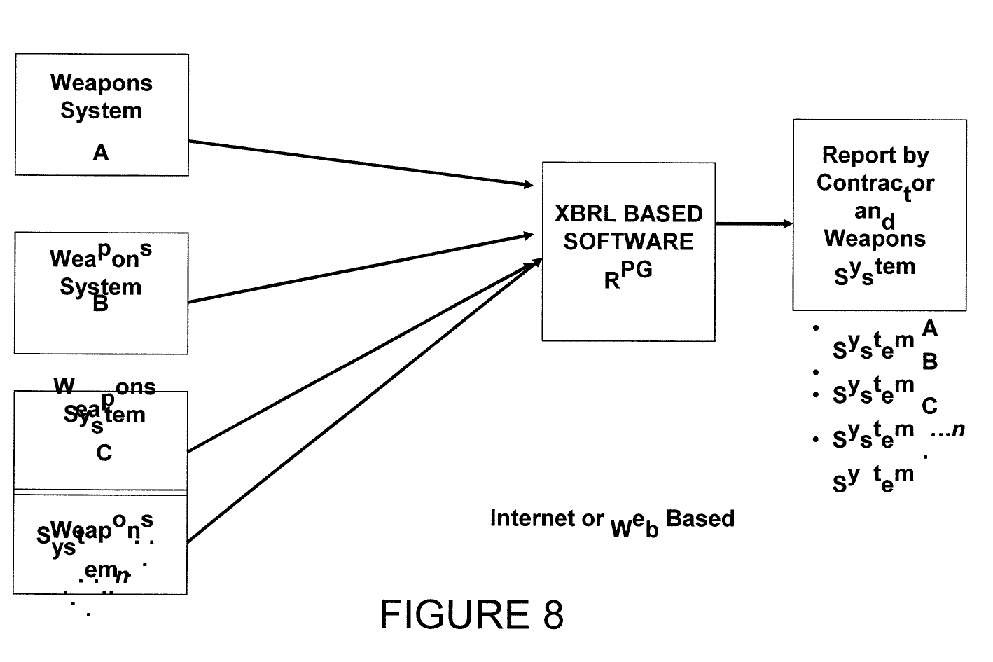

In another embodiment, a program manager or auditor wishes to review all of the multi-year changes in a facet of a weapons system performed by a specific contractor relating to a particular current cost. All of the weapons of contractor X relating to the particular current cost can be arrayed by date, size of change, or other criteria, and then computer records analyzed, the results tabulated, transmitted, and displayed remotely on a computer monitor attached to the World Wide Web. (FIG. 8.)

Some embodiments permit identification of a line item in the accounting cost system. The operator can then electronically locate all memoranda that relate to that particular line item in the weapons systems accounting records over a number of years, whether shown by years, months, or days. This computer search will produce external information relating to one cost category in the accounting record. This reduces cost and provides an assurance that all of the relevant memorandums relating to the particular cost line item were electronically identified for examination by a computer program or human being. After computer identification of the memorandum, they could be analyzed by previously specified criteria, ranked, transmitted, and displayed over the World Wide Web to any operator with the appropriate security clearance.

In another embodiment, the software can provide an electronic trail of the changes to the accounting records, acquisition contract or both. This is done by using the linkbase capabilities, the unlimited parent-child nesting capabilities only available in the XBRL software and sorting for and matching metadata relating to the accounting data. These data can be matched, compared, reported, and displayed for the program manager.

In another embodiment, the software can be used to manage and maintain data relating to ongoing machine or aircraft maintenance. Both private and commercial aircraft have to be regularly maintained and serviced with pre-determined replacement parts. On a global basis, this is a major challenge for an international carrier, e.g., Fed Ex. The database must be displayed in multiple locations on the web. When a modification to the previously established service routine is made, it must be transmitted on a world wide basis, e.g., “replace part x every 100 hours rather than 150 hours.” Unless the aircraft service is in compliance with the specified current regulatory maintenance requirements, the aircraft is denied a certificate of airworthiness and is not permitted to fly from its current location. This often happens when an aircraft is away from its home base. The XBRL software allows the aircraft servicing requirements to be entered remotely, stored on the web, transmitted world wide and displayed on remote terminals or printed. When the aircraft regulatory agency or the manufacturer changes a requirement, the change can be input into the software and related to all aircraft's maintenance requirements immediately. These can be stored, arrayed, transmitted, and displayed remotely throughout the world. When the aircraft's identifier is entered into the software, the updated regulatory requirements are displayed. When the service is completed, the service record can be updated and the certificate of airworthiness updated and issued electronically or printed. The aircraft's maintenance record is then updated and transmitted to the manufacturer, operator, and other parties interested in its airworthiness.

The software will also permit the party conducting the maintenance to anticipate the service requirement, order the necessary parts, track the inventory status, and location for the maintenance. From the data of the aircrafts flight patterns, e.g., hours of service, take offs and landings, the software will order the parts necessary for upcoming maintenance and arrange for them to be shipped to the location where the anticipated maintenance will be conducted, then update the aircraft's maintenance record and airworthiness certificate.

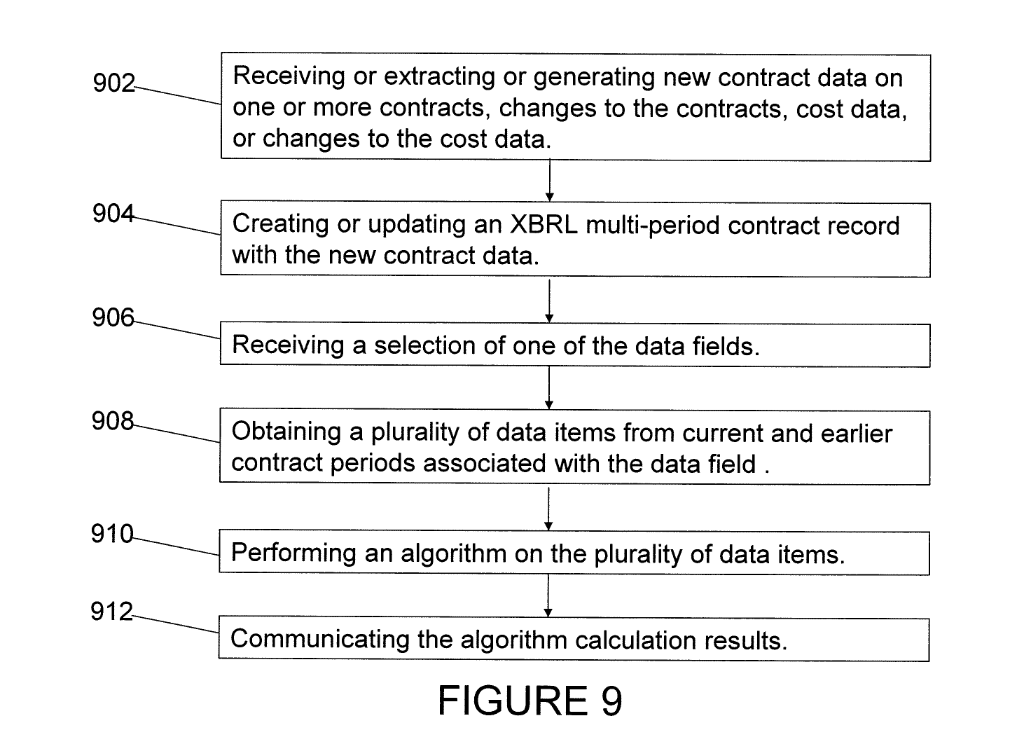

Referring now to FIG. 9, there is illustrated one embodiment of an XBRL multi-period contract management system. Block 900 comprises an operation of receiving or extracting or generating new contract data and context data therefor on one or more of contracts, changes to the contracts, cost data, changes to the cost data. In one embodiment, the contract data may be an electronic contract record in an electronic database that is accessed and retrieved by means of the Internet or other network such as an extranet or intra-net particular to an organization. The electronic database may be maintained, for example, by any organization or person performing or tasked with managing or funding the contract, or a database maintenance company. Alternatively, a facsimile of a contract record with contract data may be received and converted into an electronic contract record. Alternatively, a paper contract record with contract data may be received and converted to an electronic contract record. The method by which the contract record and data is extracted, or received or generated is not limiting on the invention.

Block 902 comprises an operation of creating or updating with the new contract data an XBRL multi-period contract record comprising XBRL data fields containing contract data made for different periods in a contract and associated components representing attributes at the data value level in the data field based on a contract taxonomy, some of the metadata relating to a pertinent time or date relating to the data, with links between and/or among at least two items selected from one or more of the categories of the data fields, metadata and components associated with the data fields in the XBRL multi-period contract record, wherein the creating or updating comprises converting the new contract data into values in one or more of the XBRL data fields and associating metadata thereto based on context data for the new contract data and forming links between and/or among at least two items selected from one or more of the categories of the data fields, metadata and components associated with the data fields in the XBRL multi-period contract record. The term “associating” is intended to encompass the act of electronically linking.

This operation comprises in one embodiment, mapping the contract data values into one or more XBRL data fields and creating based on context data, metadata representing attributes at the data value level for the data field based on a contract taxonomy and associating the metadata with the data field. This conversion into an XBRL contract record is accomplished by a conversion engine, which operates to take each of a plurality of items of data from the electronic contract record and map it or otherwise electronically transfer it into a data field in the XBRL contract record. The conversion engine further converts context data associated with the data value into metadata. For example, for a value of 1.0, there would be associated with that value in the data field a plurality of metadata identifying the number 1.0 as an cost amount, with a millions scale attribute, i.e., 1.0 means one million, with a currency attribute of U.S. dollars, with an amendment attribute of the value being the result of an amendment on Apr. 15, 2006, with a source attribute of contracting officer Jacobs of the Navy, with a reason attribute of Navy-authorized design change. In one embodiment, the conversion engine could also form selected links between and among the data fields and between and among metadata for the different data fields, and between and among each component (elements, tuples, metadata, and other resources), based on a taxonomy Alternatively, these links could be formed at a later time by means of a linking program

Block 904 comprises an operation of receiving a selection of one of the data fields. In one embodiment, this selection could be obtained by selecting a data field from a drop-down menu. In another embodiment, the data field could be selected by clicking on a data field in an electronic contract record. The method of making the selection of the data field is not limiting on the invention.

Block 906 comprises an operation of obtaining a plurality of data values from current and earlier contract periods associated with the data field. In one embodiment, this obtaining operation comprises determining a period of time or sequence of events for the data from a data field to be accessed, e.g., overall cost data for equipment item X made over the last 2 years. To obtain this data covering the last 2 years, the search engine for the XBRL database would extract overall cost data fields for equipment X having metadata for a date that covers a period of 2005 and 2006. Extraction or obtaining the data can be initiated ad hoc by an individual or automatically by a software program, and displayed and/or it can be analyzed.

Block 908 comprises an operation of performing an algorithm on the plurality of data values from the current and earlier contract periods and related attributes, metadata and other data values to obtain algorithm calculation results. In one embodiment, the data field may be an overall cost data field for equipment X, and the data values extracted may cost data in millions of U.S. dollars. The algorithm in this embodiment may be an addition algorithm to obtain a total. Alternatively, the algorithm could be an exceptions algorithm.

By way of example, for U.S. Government procurement, there may be Congressional bill passed into law authorizing the design and purchase of a tank. There would be a subsequent Congressional bill passed into law appropriating $100 million to design and build the tanks. An accounting obligation would then be generated allocating $10 million to build a prototype tank. An actual disbursement of funds of $10 million would then be made to build the prototype tank, and this $10 million disbursement would be marked against the $10 million accounting obligation. The issue presented is to link the $10 million disbursement back to the $10 million accounting obligation, back to the law appropriating the $100 million for the tanks, back to the law authorizing the design and purchase of the tanks. This can be done by associating/linking all of these elements in the XBRL record. In one embodiment, the algorithm could search and retrieve the appropriate documents based on context data and form an electronic link therebetween and determine if there is an exception, e.g., a failure to link back to sufficient funds in an accounting obligation and an appropriation. This operation could be accomplished in one embodiment, by means of one or more comparison and/or subtraction or other operations between the disbursement and the accounting obligation and the appropriated amount. Alternatively, the linking might already be present, so that the algorithm would just perform the exceptions calculation.

In another embodiment, the exceptions algorithm would track a disbursement back to a contract equipment change, to an accounting obligation, to an appropriated amount. The exceptions algorithm could perform a further summing of disbursement made against that accounting obligation to determine if there is an overage, or how much of the accounting obligation amount and/or the appropriated amount remain.

Block 910 comprises the operation of communicating the algorithm calculation results. The communication operation may be implemented by a presentation on a video display on any convenient electronic device, or via a communication of a text message, or a paper printout, or a printing or communication of a barcode, or via an email, or via a network communication, or a Web service, or to an RFID tag, or any other mode of communication. The mode of communication is not limiting on the invention. In one embodiment, the communication may be made to a video screen in an auditor's office. In another embodiment, the communication may be a network communication to an electronic database at a budget facility.

In a further embodiment, the data field is a disbursement data field, and wherein the algorithm determines if a change to a disbursement data item has associated therewith a valid change authority.

In a further embodiment, the data field is a disbursement data field, and wherein the exceptions algorithm determines if a disbursement data item is associated with or correlates to an authorized appropriation amount.

In a further embodiment, the data items from the earlier contract periods are ranked based on a criterion. By way of example, the criterion could be age, appropriate law, fiscal year, to name a few.

In a further embodiment, the data field is a cost data field, and wherein the algorithm selects changes to cost data items in the cost data field made in the past.

In a further embodiment, changes to the cost data item are correlated with changes to equipment being procured under the contract.

In a further embodiment, the data field is a cost data field, and wherein the algorithm determines if a change to a cost data item has associated therewith a valid change authority.

In a further embodiment, the data field is a maintenance record field for equipment procured under the contract, and wherein XBRL links are provided between the maintenance record data field and one or more XBRL values in data fields for past maintenance activity, past maintenance cost, maintenance disbursement, a due date for a next maintenance, funds available for the next maintenance, and one or more drawings for the equipment, and wherein the algorithm calculates a parameter based on the one or more XBRL values.

In a further embodiment, the algorithm calculates a projected cost based at least in part, on one or more past maintenance cost data values.

In a further embodiment, the algorithm determines if a disbursement data item is associated with or correlates to a valid maintenance disbursement authority.

In a further embodiment, the received contract data is from a plurality of different contracts.

### Description of the Invention

The invention in a further embodiment is an Extensible Business Reporting Language (“XBRL”) enhanced Extensible Markup Language (“XML”) based software application that is used by an entity to procure goods and services. Over the web, the XML/XBRL application software permits the purchasing entity to specify and broadcast its procurement requirements, and process XBRL standardized responses from vendors.

Using the software, a potential vendor can learn the procuring entity's purchasing specifications and determine whether the vendor's product or services may meet the procurement specifications.

The software also permits the electronic linking of external memoranda relating to the procurement and the entry of the relevant data into the procuring entity's accounting system. With one click of a computer mouse, a procuring entity can locate and electronically read an external memorandum that explains the procurement specifications, vendors' submission, its acceptance, and entry into the procuring entity's accounting system. This ensures that a user can electronically locate a related procurement memorandum prepared before, at the time, or after the data entry that explains the data entry or other relevant information to the financial entry relating to the procurement.

Some embodiments ensure that the relevant memorandum will be located and electronically linked to procuring entity's accounting system data entry. This feature eliminates human searches and the errors that human searches can introduce to relating the accounting entry to the rationale or justification for the accounting entry. This saves time and increases accuracy when managing any multi vendor, multi-location, or multi-year contract, or subsequently performing an audit of the procurement contract. The information can be transmitted electronically and displayed remotely.

### Embodiments

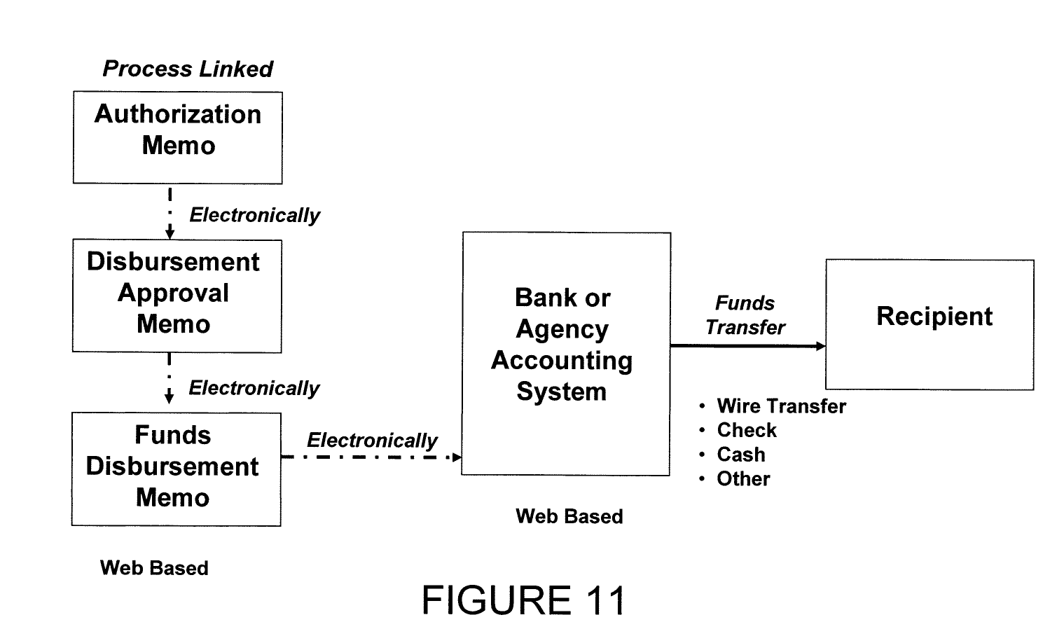

In a plurality of the following embodiments, the XBRL procurement software will have two components; a human readable component, and the computer machine readable component. Examples of the human readable component are current software programs such as Word, Excel, or displays using HTML or PDF data formats. The procurement specifications, vendor responses, etc. would be transmitted and displayed in human readable and XBRL machine readable formats. All of these software or data formats could be XBRL enabled so that in machine language or machine readable format, the data would have been standardized using an XBRL taxonomy and XBRL processor to normalize the data and make it machine readable in XBRL. A human reading the transmitted computer display or completing the formatted request for bids would see only the human readable format they are used to seeing, e.g. an Excel spread sheet format. However, that Excel spread sheet or other XBRL enabled human readable software would be automatically processed into XBRL for the computer. The computer would perform any operations on data in the XBRL format and transmit and display it in human readable format for human consumption. (See FIG. 11.)

The invention in one embodiment is an Extensible Business Reporting Language (“XBRL”) enhanced Extensible Markup Language (“XML”) based application software that electronically links a data entry in an accounting system with an external memorandum. Over the web, the XML/XBRL application software linkbase base feature will automatically link the numeric entry in the financial records with an alphanumeric memorandum explaining the context or rationale for the numeric entry in the accounting or financial records. The memorandum may be linked at the time the numeric financial entry is entered into the accounting records or linked at a subsequent time. The XBRL records will be based upon a disbursement taxonomy.

A taxonomy for disbursement data could be implemented, for example, by multiple disbursement agencies or banks, or a consortium of experts, designing a taxonomy for the values or ranges of values that would be measured for a given data field. The taxonomy developers would typically also build in a plurality of conformance tests on each data item to insure that each data item entered/matched into a data field was within its appropriate data field parameter location. These conformance tests would comprise the application of one or more business rules to specify what data could go into a data field and not accepting any data that does not meet one or more rules by checking both data types and semantic meanings of the data input to the field. For example, only certain authorized name values could be input into a disbursement authority data field, or alternatively, if an unauthorized name was entered, a flag could be set to cause some form of indication.

The invention ensures that the relevant memorandum (Authorization, Disbursement Approval, and Funds Disbursement Order) are electronically linked to the disbursing bank or agency's accounting system data entry. This feature eliminates human searches and the errors that human searches can introduce relating the accounting entry to the rationale or justification for the accounting entry. This saves time and increases accuracy when managing any multi-year disbursement program, or subsequently performing an audit of the disbursement program.

The results of the linkbase search can be analyzed, transmitted, and displayed on any computer screen with access to the World Wide Web. The software will retrieve multiple external memoranda, prepared at differing times, with the numeric entry into the accounting system, sort or rank them by pre-determined criteria, e.g. date, perform Boolean algebra searches between and among them, and the results compiled and transmitted to a remote computer screen and displayed for viewing, or printing out into a hard copy record.

In one embodiment, a multi-year disbursement agreement is initiated by a bank, multilateral financial institution, or granting agency. Over a number of time periods, Authorization Memoranda, Disbursement Approval Memoranda, and Funds Disbursement Orders are prepared and funds disbursed and the disbursement recorded on the bank or disbursing agency's computerized general ledger for funds disbursements. At the time of audit, all of the memoranda are electronically linked to the funds disbursement for audit purposes. (FIG. 11)

In a second embodiment, a multi-year disbursement agreement is initiated by a bank, multilateral financial institution, or granting agency. Over a number of time periods, Authorization Memoranda, Disbursement Approval Memoranda, and Funds Disbursement Orders are prepared in accordance with the XBRL software business rules in the accounting system and therefore funds is disbursed and the disbursement recorded on the bank or disbursing agency's computerized general ledger for funds disbursements. At the time of audit, all of the memoranda are electronically linked to the funds disbursement for audit purposes, and there is a record that all of the memoranda were in order. In this embodiment, the XBRL based business rules of the disbursing bank or entity are pre-established in the accounting system. One or more business rules might set forth authorized amounts for a data field and relationships for that amount, names of persons authorized to disburse funds, names of persons that are authorized recipients, milestone requirements, to name a few.

If the pre-established business rules criteria for the Authorization Memorandum are met, and the signature is authenticated, then the accounting entry for the Authorization Memorandum is tested, validated, and accepted by the XBRL based accounting system. Under the XBRL business rules, this acceptance of the Authorization Memorandum permits the accounting system electronically to test, validate, and accept the Disbursements Approval Memorandum.

If the pre-established business rules criteria for the Disbursements Approval Memorandum are met, and the signature is authenticated, then the accounting entry for the Disbursements Approval Memorandum is also tested, validated, and accepted by the XBRL based accounting system. Under the XBRL business rules, this acceptance of the Disbursements Approval Memorandum permits the accounting system electronically to test, validate, and accept the Funds Disbursements Order.

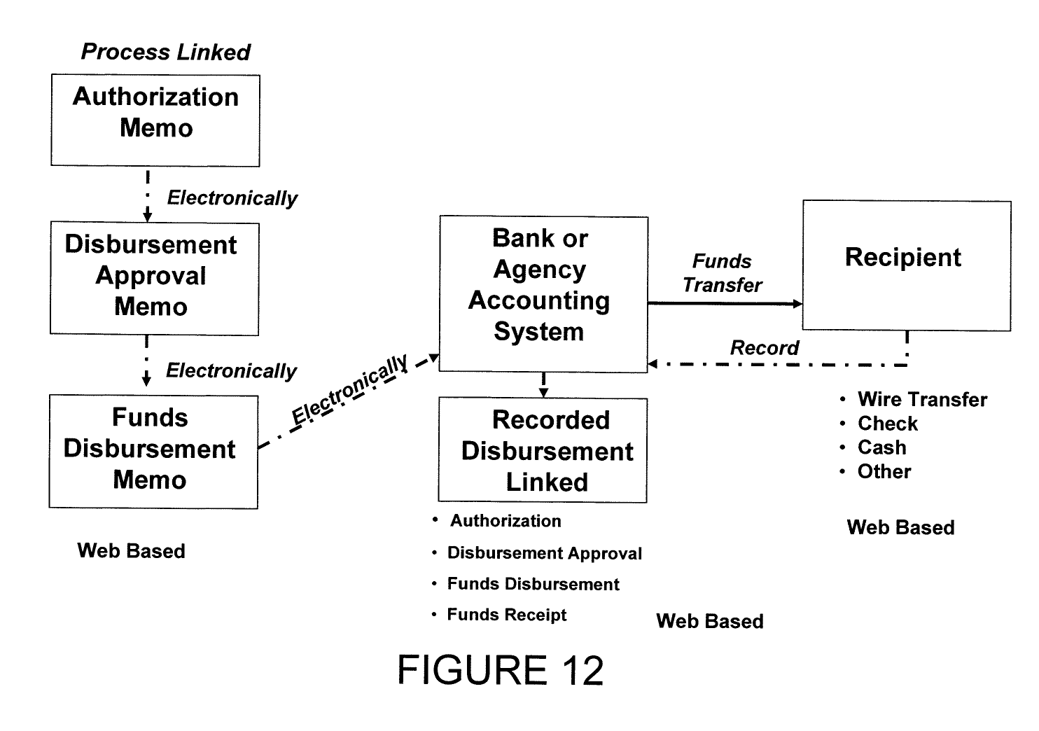

If the pre-established business rules criteria for the Funds Disbursements Order are met, and the signature is authenticated, then the accounting entry for the Funds Disbursements Order is also tested, validated, and accepted by the XBRL based accounting system. Under the XBRL business rules, this acceptance of the Funds Disbursements Order permits the accounting system to accept a disbursement that meets the XBRL business rules. That is, the disbursement by approved means, wire transfer, certified or registered check, direct deposit into authorized account, or funds disbursement may be made. (FIG. 12)

This embodiment has established an electronic audit trail of all of the necessary authorizations, tested the documents using business rules, and verified that the disbursement is according to pre-established XBRL business rules. Failure to meet the business rules authorizations will terminate the transaction at the point the business rules are violated and prevent a disbursement, while establishing an electronic audit record of the attempted but invalid disbursement that was terminated.

In a third embodiment, a disbursing bank or agency's manager or auditor wishes to review all of the disbursements to a disbursing agent or intermediate recipient. The intermediate recipient will typically make micro-disbursements of the loan or grant to the ultimate recipients. The intermediate recipient may have the identical XBRL disbursement application software as the originating lender or agency.

If the intermediate recipient's pre-established business rules criteria for the Authorization Memorandum are met, and the signature is authenticated, then the accounting entry for the Authorization Memorandum is tested, validated, and accepted by the XBRL based accounting system. Under the XBRL business rules, this acceptance of the Authorization Memorandum permits the accounting system electronically to test, validate, and accept the Disbursements Approval Memorandum.

If the intermediate recipient's pre-established business rules criteria for the Disbursements Approval Memorandum are met, and the signature is authenticated, then the accounting entry for the Disbursements Approval Memorandum is tested, validated, and accepted by the XBRL based accounting system. Under the XBRL business rules, this acceptance of the Disbursements Approval Memorandum permits the accounting system electronically to test, validate, and accept the Funds Disbursements Order.

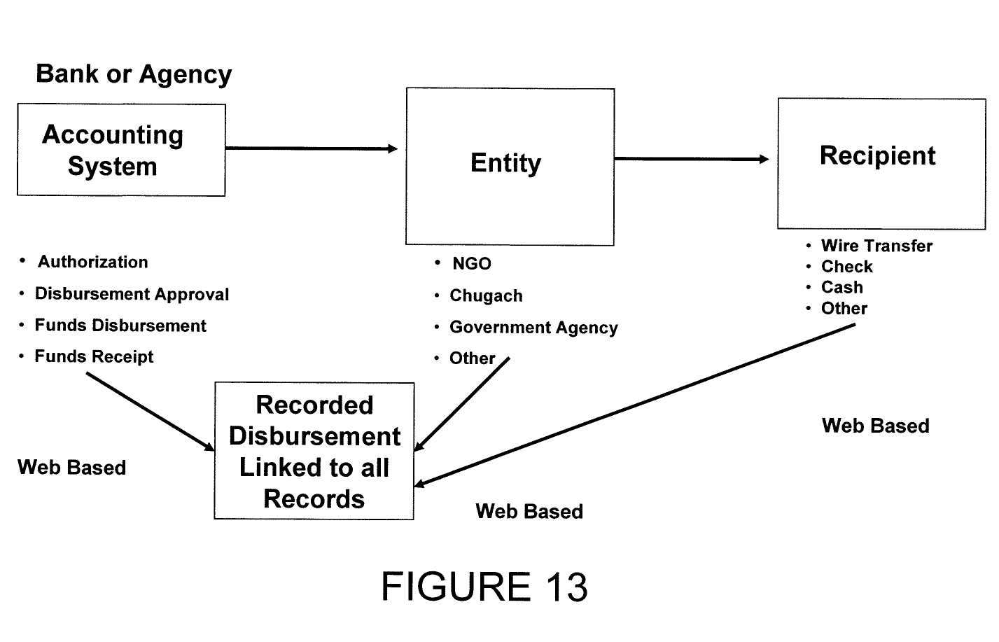

If the intermediate recipient's pre-established business rules criteria for the Funds Disbursements Order are met, and the signature is authenticated, then the accounting entry for the Funds Disbursements Order is tested, validated, and accepted by the XBRL based accounting system. Under the XBRL business rules, this acceptance of the Funds Disbursements Order permits the accounting system to accept a disbursement that meets the XBRL business rules. That is, the intermediate recipient's disbursement by approved means, wire transfer, certified or registered check, direct deposit into authorized account, or funds disbursement may be made. (FIG. 13)

This embodiment has established an electronic audit trail of all of the necessary authorizations, tested the documents, and verified that the disbursement is according to pre-established XBRL business rules. Failure to meet the business rules authorizations will terminate the transaction at the point the business rules are violated and prevent a disbursement, while establishing an electronic audit record of the attempted but invalid disbursement that was terminated.

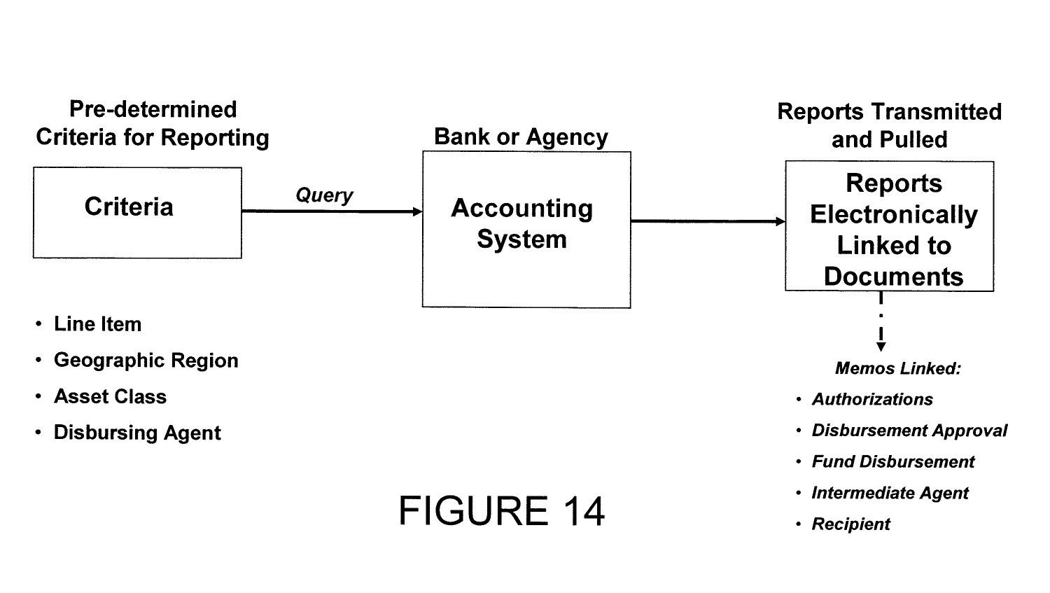

All of the disbursements by a disbursing agent or intermediate recipient can be arrayed by date, size of change, or other criteria, and then the computer records analyzed, the results tabulated, transmitted, and displayed remotely on a computer monitor attached to the World Wide Web. (FIG. 14)

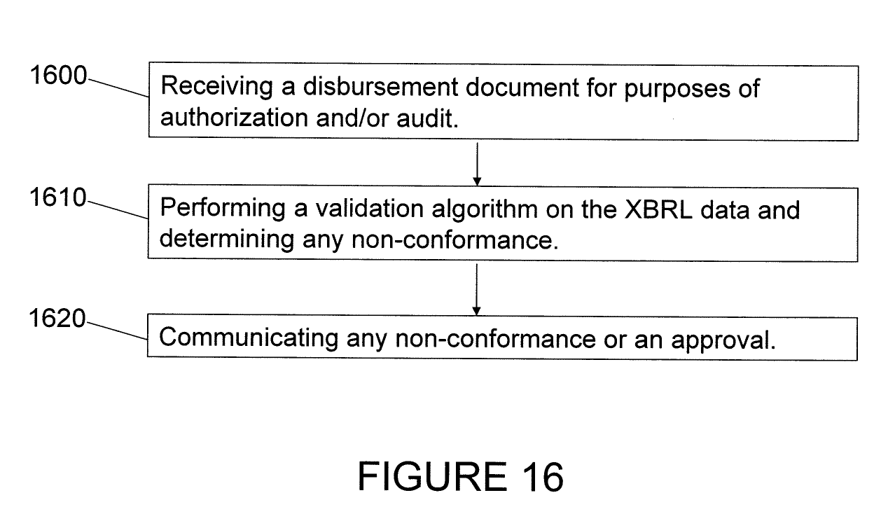

Referring now to FIG. 16, there is illustrated one embodiment of a method for financial compliance. Block 1600 comprises an operation of receiving a disbursement document for purposes of authorization and/or audit, wherein disbursement data in the disbursement document is extracted as XBRL data and/or converted to XBRL data with associated components representing attributes at the data value level in the data field based on a disbursement taxonomy and including links to data relating to at least one from the group of authorization documents and explanation documents and appropriation documents

As mentioned above, a multi-year disbursement agreement may be initiated by a bank, multilateral, financial institution or granting agency. A reviewer, such as a disbursing bank, agency manager, or auditor, may review a disbursement. The reviewer may choose to review all of the disbursements made to a specific recipient or agent, or by date, or some other pre-determined or user-inputted criterion.

In one embodiment, one of the data fields may be an authorization field, with metadata associated with that data field that includes one or more names of persons who can authorize the disbursement. The validation algorithm would compare a name in the authorization field to one or more persons in the metadata associated with the field who are able to authorize the disbursement.

In another embodiment, one of the data fields is a recipient field, which, in a manner similar to the authorization field, allows comparison by the validation algorithm of names in the recipient field to those one or more persons eligible to receive the disbursement.

In another embodiment, one of the data fields is a milestones met field. The validation algorithm compares a milestones met value in the milestones met data field to one or more milestones that must be met to qualify for the disbursement. This data field may include information regarding when those milestones must be met, or by whom. Any other additional data pertinent to the field could be included or linked to the field. For example, documents asserting that milestones are met may be linked to the data field. Explanations as to what constitutes “meeting” a milestone may also be linked to the data field. In another embodiment, the data field may comprise a disbursement amount and business rules that add the entered disbursement with previous disbursement and compares the summed result to an authorized amount for a given period. A flag could be set if there is an overage or the system could prevent acceptance of the entry.

In another embodiment, explanations of each data field and the attributes associated with each data field are included as another attribute of each data field. These explanations may also be included in a document linked to each data field.

In another embodiment, business rules are associated with each data field, either as attributes of the data field, as a document linked to each field.

Block 1610 comprises an operation of performing a validation algorithm on the XBRL data and determining any non-conformance.

In one embodiment, the validation algorithm retrieves an explanation of a data field found and business rules associated therewith. The validation algorithm may retrieve the explanations of a data field found and business rules associated therewith in a plurality of documents and then rank by a predetermined criterion. The predetermined criterion includes, but is not limited to, fields such as date of creation, amount of disbursement, size of change, and milestones met, to name a few.

In another embodiment, the validation algorithm retrieves all of the data (and its associated components) over a period of time for a given data field. The validation algorithm then performs an algorithm on the retrieved data. This algorithm could be, for example, an addition and comparison algorithm as described above.

The algorithm could also be a line item analysis, such as that detailed below. The invention permits the identification, aggregation, and analysis of a line item or type of disbursement in the accounting cost system. For example, the line item for “computer equipment” in all disbursements in a period of time by the program lender, agency or their intermediate recipient's disbursements for “computer equipment” can be identified by the XBRL metadata on each data entry into the accounting system. The validation algorithm can then electronically locate all memoranda that relate to “computer equipment” over any time period, days, weeks, months, quarters, or years and may also perform an algorithm on the disbursement values, such as the addition and comparison algorithm noted previously.

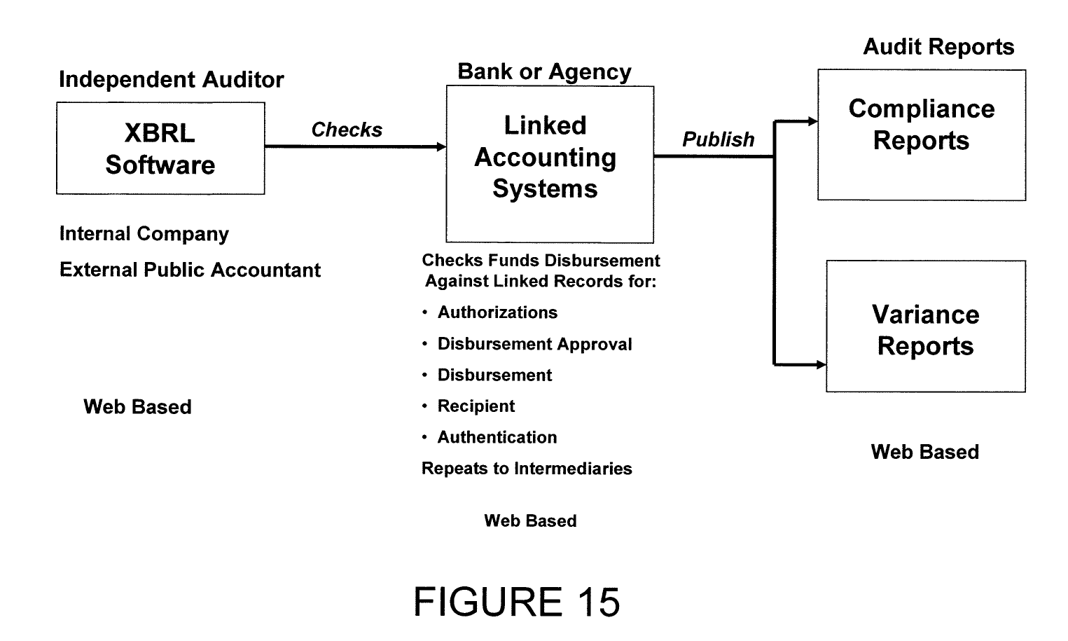

This computer search will produce external information in the memorandum relating to “computer equipment in the XBRL accounting record. This reduces cost and provides an assurance that all of the relevant memorandums relating to the particular cost line item were electronically identified for examination by a computer program or human being. After computer identification of all memoranda mentioning “computer equipment” and the line items for “computer equipment” in the accounting records, the data could be analyzed by previously specified criteria, ranked, transmitted, and displayed over the World Wide Web. (FIG. 15)

The bank disbursements, like the contract disbursements and the weapons systems audit are all designed to track where the money went, who got it, and what justification memos support the change in contract, disbursements, etc. For example, the World Bank would be able to find out that the money for schools in country X instead went to buy Land Rovers for the Ministers cousins. They are all designed to take advantage of the electronic audit trail feature of XBRL by linking documents to disbursement orders, e.g., the software won't permit a disbursement from a bank account without a justification (disbursement order). Today these documents aren't linked in any way.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

What is claimed is:

1. A method for managing a multi-period contract, comprising:
receiving or extracting or generating new contract data on one or more of contracts, changes to the contracts, cost data, changes to the cost data;
creating or updating with the new contract data an XBRL multi-period contract record comprising XBRL data fields containing contract data made for different periods in a contract and associated metadata representing attributes at the data field level based on a contract taxonomy, some of the metadata relating to a pertinent time or date for the data, wherein the creating or updating comprises converting the new contract data into values in one or more of the XBRL data fields and associating metadata thereto based on context data for the new contract data and forming links between and/or among at least two items selected from one or more of the categories of the data fields, metadata and components associated with the data fields in the XBRL multi-period contract record;
receiving a selection of one of the data fields;
obtaining a plurality of data items from current and earlier contract periods associated with the data field;
performing an algorithm on the plurality of data items from the current and earlier contract periods to obtain algorithm calculation results; and
communicating the algorithm calculation results.

2. The method as defined in claim 1, wherein the data field is a disbursement data field, and wherein the algorithm determines if a change to a disbursement data item has associated therewith a valid change authority.

3. The method as defined in claim 1, wherein the data field is a disbursement data field, and wherein the algorithm determines if a disbursement data item is associated with or correlates to an authorized appropriation amount.

4. The method of claim 1, wherein the data items from the earlier contract periods are ranked based on a criterion.

5. The method as defined in claim 4, wherein the criterion is fiscal year.

6. The method as defined in claim 1, wherein the data field is a cost data field, wherein the obtaining step obtains changes to cost data items in the cost data field made in the past, and wherein changes to the cost data item are correlated with changes to equipment being procured under the contract.

7. The method as defined in claim 1, wherein the data field is a cost data field, and wherein the algorithm determines if a change to a cost data item has associated therewith a valid change authority.

8. The method as defined in claim 1, wherein the data field is a maintenance record field for equipment procured under the contract, and wherein XBRL links are provided between the maintenance record data field and one or more XBRL values in data fields for past maintenance activity, past maintenance cost, maintenance disbursements, a due date for a next maintenance, funds available for the next maintenance, and one or more drawings for the equipment, and wherein the algorithm is a maintenance algorithm that calculates a parameter based on the one or more XBRL values.

9. The method as defined in claim 8 wherein the maintenance algorithm calculates a projected cost based at least in part, on one or more past maintenance cost data values.

10. The method as defined in claim 9, wherein the maintenance algorithm determines if a disbursement data item is associated with or correlates to a valid maintenance disbursement authority.

11. The method as defined in claim 1, wherein the received contract data is from a plurality of different contracts.

12. A system for managing a multi-period contract, comprising:
a data repository; and
one or more processors operably connected to the data repository for implementing the following components:
a component for receiving or extracting or generating new contract data on one or more of contracts, changes to the contracts, cost data, changes to the cost data;
a component for creating or updating with the new contract data an XBRL multi-period contract record comprising XBRL data fields containing contract data made for different periods in a contract and associated metadata representing attributes at the data field level based on a contract taxonomy, some of the metadata relating to a pertinent time or date for the data, wherein the creating or updating comprises converting the new contract data into values in one or more of the XBRL data fields and associating metadata thereto based on context data for the new contract data and forming links between and/or among at least two items selected from one or more of the categories of the data fields, metadata and components associated with the data fields in the XBRL multi-period contract record;
a component for receiving a selection of one of the data fields;
a component for obtaining a plurality of data items from current and earlier contract periods associated with the data field;
a component for performing an algorithm on the plurality of data items from the current and earlier contract periods to obtain algorithm calculation results; and
a component for communicating the algorithm calculation results.

13. A program product for managing a multi-period contract, comprising:
one or more computer usable media having computer readable program code embodied therein or among them, to be executed by a computer, the computer readable program code comprising:
program code for receiving or extracting or generating new contract data on one or more of contracts, changes to the contracts, cost data, changes to the cost data;
program code for creating or updating with the new contract data an XBRL multi-period contract record comprising XBRL data fields containing contract data made for different periods in a contract and associated metadata representing attributes at the data field level based on a contract taxonomy, some of the metadata relating to a pertinent time or date for the data, wherein the creating or updating comprises converting the new contract data into values in one or more of the XBRL data fields and associating metadata thereto based on context data for the new contract data and forming links between and/or among at least two items selected from one or more of the categories of the data fields, metadata and components associated with the data fields in the XBRL multi-period contract record;
program code for receiving a selection of one of the data fields;
program code for obtaining a plurality of data items from current and earlier contract periods associated with the data field;
program code for performing an algorithm on the plurality of data items from the current and earlier contract periods to obtain algorithm calculation results; and
program code for communicating the algorithm calculation results.

14. A method for financial compliance, comprising:
receiving a disbursement document for purposes of authorization and/or audit, wherein disbursement data in the disbursement document is extracted as XBRL data and/or converted to XBRL data with associated metadata representing attributes at the data value level in the data field based on a disbursement taxonomy and including links to data relating to at least one from the group of authorization documents and explanation documents and appropriation documents;
performing a validation algorithm on the XBRL data and determining any non-conformance; and
communicating any non-conformance or an approval.

15. The method as defined in claim 14, wherein there is a non-conformance, and further comprising:
determining a materiality of the non-conformance in the audit trail.

16. The method as defined in claim 14, wherein one of the data fields is an authorization field, and wherein the validation algorithm compares a name in the authorization field to one or more persons who can authorize the disbursement.

17. The method as defined in claim 14, wherein one of the data fields is a recipient, and wherein the validation algorithm compares a name in the recipient field to one or more persons eligible to receive the disbursement.

18. The method as defined in claim 14, wherein one of the data fields is a milestones met field, and wherein the validation algorithm compares a milestones met value in the milestones met data field to one or more milestones that must be met to qualify for the disbursement.

19. The method as defined in claim 14, wherein the validation algorithm retrieves an explanation of a data field found and business rules associated therewith.

20. The method as defined in claim 14, wherein the validation algorithm retrieves an explanation of a data field found and business rules associated therewith in a plurality of documents and ranks them by a predetermined criterion.

21. The method as defined in claim 20, wherein the predetermined criterion is date of creation.

22. The method as defined in claim 14, wherein the validation algorithm retrieves all data values over a period of time for a given data field and performs an algorithm on the retrieved data values.

23. The method as defined in claim 11, wherein the algorithm is an addition algorithm.

24. A system for financial compliance, comprising:
a data repository; and
one or more processors operably connected to the data repository for implementing the following components:
a component for receiving a disbursement document for purposes of authorization and/or audit, wherein disbursement data in the disbursement document is extracted as XBRL data and/or converted to XBRL data with associated metadata representing attributes at the data value level in the data field based on a disbursement taxonomy and including links to data relating to at least one from the group of authorization documents and explanation documents and appropriation documents;
a component for performing a validation algorithm on the XBRL data and determining any non-conformance; and
a component for communicating any non-conformance or an approval.

25. A program product for financial compliance, comprising:
one or more computer usable media having computer readable program code embodied therein or among them, to be executed by a computer, the computer readable program code comprising:
program code for receiving a disbursement document for purposes of authorization and/or audit, wherein disbursement data in the disbursement document is extracted as XBRL data and/or converted to XBRL data with associated metadata representing attributes at the data value level in the data field based on a disbursement taxonomy and including links to data relating to at least one from the group of authorization documents and explanation documents and appropriation documents;
program code for performing a validation algorithm on the XBRL data and determining any non-conformance; and
program code for communicating any non-conformance or an approval.
